(19) United States
(12) Patent Application Publication
(10) Pub. No.: US 2006/0216535 A1
(43) Pub. Date: Sep. 28, 2006

(54) Process for the production of an oriented plastic film

(76) Inventors: Walter Gunter, Forchheim (DE); Michael Bauer, Forchheim (DE); Siegfried Schmitzer, Forchheim (DE)

Correspondence Address: WILLIAM COLLARD;COLLARD & ROE, P.C., 1077 NORTHERN BOULEVARD, ROSLYN, NY, 11576, US

(21) Appl. No.: 11/389,921

(22) Filed: Mar. 27, 2006

(30) Foreign Application Priority Data
Mar. 27, 2005 (DE) 10 2005 014 474.8

(51) Int. Cl. B32B 27/32; B32B 27/34; B29C 47/06; B29C 47/88; B29C 47/92

(52) U.S. Cl. 428/474.4; 428/521; 428/910; 264/564; 264/510; 264/290.2; 264/40.6; 264/211.12; 264/129; 156/244.11

(57) ABSTRACT

Process for the production of an oriented plastic film from polyolefins and/or combinations of polyolefins and polyamide that are manufactured by the extrusion and/or coextrusion blowing process, where initial biaxial orientation is carried out during the blowing process and this is followed by another orientation operation.

### BACKGROUND OF THE INVENTION

1. Field of the Invention

The invention relates to a process for the production of an oriented plastic film from polyolefins and/or combinations of polyolefins and polyamides, the film being manufactured by the extrusion and/or coextrusion blowing process.

2. The Prior Art

Such films are familiar from the prior art, but all of them have the disadvantage that they are either comparatively thick or do not have optimum properties for the respective application.

### DESCRIPTION OF THE INVENTION

The purpose of the invention is to propose a production process that on the one hand enables thin films to be manufactured in the blown film process and on the other hand allows the mechanical and physical properties of the film manufactured to be varied within wide limits.

In the invention, initial biaxial orientation is carried out during the blowing process and this is followed by another orientation operation.

This not only reduces the thickness of the film but also improves the properties of the film manufactured.

In one embodiment of the process, the second orientation operation is carried out directly after the initial orientation. It is, however, also possible in accordance with the invention that the second orientation operation is carried out independently of the initial orientation.

It is also very advantageous if at least the initial orientation is carried out biaxially at the same time.

The properties of the film are improved considerably by the subsequent second orientation operation. A further improvement is achieved by the biaxial orientation.

In another embodiment, the temperature of the blown film for orientation is set at 90 to 180° C. depending on the plastic material used for production. The thermoelastic range is reached as a result. Cooling at the end of the blowing operation is carried out primarily by cooling fans. It has also proved to be very advantageous if temperature regulation rollers are used to regulate the temperature of the film before the second orientation operation and set the film temperature at about 100 to 180° C.

It is also very advantageous if the film is heated up to the required orientation temperature of about 100 to 180° C. by radiant heaters before the second orientation operation. Effective regulation of the film temperature is guaranteed by both processes.

It is also advantageous if the film temperature is regulated after orientation, with a temperature of 90 to 180° C. being reached in the film. The film conditions achieved during orientation are set as a result.

The film is preferably cooled before winding. This makes sure that the individual layers of wound film do not stick together unintentionally.

A finished inner or outer layer is preferably fed in, to which the further layers are applied by the coextrusion blowing process. Multilayer composites can be produced as a result, the individual layers or layer groups of which have different melt flow indices.

In another embodiment, the film is siliconized on one or both sides. This makes it possible to use the finished film as a release film too. Handling of the film during production is improved as well. It has proved to be very advantageous in this context if the siliconization agent is extruded together with the film. However, the siliconization agent can also be applied by extrusion afterwards. Both processes have advantages depending on the siliconization agent used. It is also conceivable that a different substance with low adhesive properties is used instead of a siliconization agent.

In another embodiment, orientation is carried out with a ratio of between 3:1 and 25:1, preferably 7:1. Such orientation ratios produce very good results as regards the strength, stiffness and transparency of the film.

It has also proved to be extremely advantageous if the blown film bubble is collapsed and bonded to itself and/or another layer of film is fed in before the second orientation operation. This increases the thickness of the basic film substantially, as a result of which it can be oriented with a larger orientation ratio.

It has also proved to be very advantageous if the film layers are treated in such a way that they are able to slip on each other at room temperature. This means that the individual film layers can be shifted and positioned exactly with respect to each other.

It is in addition very advantageous if the film bubble is stuck together. This bonds the film bubble to itself very effectively.

In another embodiment, the individual film layers are provided with a layer that melts at a low temperature. Preferably, the layer that melts at a low temperature is made from PE or a similar material. The film layers are preferably bonded to each other by orientation via the layer that melts at a low temperature. Preferably, the film layers are stuck together by the orientation operation.

It has also proved to be extremely advantageous if the adhesion between the film layers is increased to such an extent by the orientation operation that they stick to each other sufficiently.

A layer that melts at a low temperature has the ability due to the energy generated in orientation to establish contact with a further layer in such a way that the layers are bonded to each other firmly. Depending on the materials used, this can lead to bonding of the layers via a layer that melts at a low temperature and/or to at least such high adhesion that the film composite is held together.

In one embodiment, the second orientation operation is carried out in the form of roller orientation. In another embodiment, the second orientation operation is carried out in the form of gripper orientation. Both processes have advantages, depending on the materials used and the possible orientation ratio and/or depending on the type of orientation.

It has also proved to be extremely advantageous in accordance with the invention if the film bubble is structured as a multilayer coextrudate. If the bubble is produced as a multilayer coextrudate, operations in the production of a composite consisting of several individual layers are saved.

In another embodiment, the second orientation operation is only carried out when several film layers have been combined to form a multilayer composite. It has also proved to be very advantageous if at least one film layer is produced from polyamide, polypropylene and/or polyethylene. It is also extremely advantageous if at least one film layer is provided with fillers. The positive properties of each of the individual materials are combined by film layers made of different materials.

In another very advantageous further development of the invention, the film layer is filled with microcapsules. It has also proved to be very advantageous if at least one film layer is foamed. It has proved to be very advantageous in this context if the foaming process is carried out by microcapsules.

The composite as a whole can be given special properties with the help of film layers filled with microcapsules or with foamed film layers. It is, for example, conceivable as a result to increase the insulation properties of the composite, to alter the surface roughness or to change the opacity of the composite.

In another embodiment, amorphous areas are provided in at least one film layer. The amorphous areas are preferably structured in such a way that they are still amorphous during and after an orientation operation. Both optical and mechanical properties of the film can be influenced with amorphous areas of a film layer. It is, however, also conceivable to create a writable film in this way. It has also proved to be very advantageous if the film is designed to be a stiff film. It is in general very complicated to produce stiff films, and they are very thick. Comparable stiffness properties are achieved by the oriented multilayer structure.

It has proved to be very advantageous in this context if the film has good optical properties. Good optical properties can only be achieved with great difficulty if at all with conventional stiff films.

The film is preferably designed to be transparent. Films that are both transparent and stiff have been extremely difficult to produce up to now and/or are very thick.

In another embodiment of the invention, the film is structured and produced in such a way that it displays minimal shrinkage. Minimal shrinkage can be achieved by orientation with subsequent temperature regulation or by a combination of several film layers made from different raw materials.

It is also very advantageous in accordance with the invention if the film has good tear properties. It has, however, also proved to be very advantageous if the film has poor tear properties due to the sequence of the individual film layers. It is also very advantageous if the tear properties are determined by partial and/or complete adhesion of individual film layers to each other.

The tear properties of the composite can be set very effectively by combining several materials and, possibly, orientation operations with different alignments.

In another very advantageous further development of the invention, the individual film layers are comparatively thin.

In another very advantageous further development of the invention, a plurality of film layers is provided, which form a comparatively thick film composite together. It has proved to be extremely advantageous in this context if the entire composite is oriented and the thickness of the composite is reduced significantly as a result. A thin film is again produced in this way which, however, combines the positive properties of the individual layers and has the overall properties that only considerably thicker films have.

The process is carried out in such a way that, for example, polyproplyene is extruded from an annular die, with it being possible for several extruders to feed into this annular die. It is, however, also possible to provide further annual dies concentrically with the first annular die. Further layers of identical or different plastics and tie layers etc. can be coextruded via the several extruders and/or annular dies.

Blends of PP with LLDPE or blends of PP with what are known as compatibilizers can be used instead of PP too. Polyamide can be used as the core layer as well. It is in addition possible to use fillers for strength modification purposes. Fillers can also be added that increase film breathability, particularly in connection with orientation.

Good insulation properties or good film breathability can, for example, be achieved by using microcapsules and/or foamed film layers. It is also conceivable that particularly good writability of the film composite can be achieved by special additives, which, for example, are embedded in film layers as microcapsules, or by amorphous film layers.

Suitable polymers can be used in order to achieve advantageous anchoring of a silicone layer.

It is possible to produce several layers at the same time in coextrusion; seven layers were coextruded simultaneously in a preferred embodiment.

The extruded bubble is cooled to such an extent that comparatively large film thicknesses are achieved in the blowing process. Film thicknesses of about 200 μm can be produced in this way. Considerably higher film thicknesses can be achieved by combining several film layers that are bonded to each other or by sticking or bonding the film bubble produced to itself.

A significant reduction in the film thickness can be achieved while maintaining the properties of the thick film structure by means of subsequent orientation.

It is, for example, conceivable that “stiff” films are produced by combining a plurality of different film layers. Very thin films that are nevertheless stiff of a kind unknown in the past are produced by the subsequent orientation operation and associated thinning of the composite.

The bubble dimensions are determined by sizing. Both non-contact sizing and sizing by systems touching the bubble are possible in this context.

In another embodiment, a finished inner or outer layer is fed in, to which the further layers are applied by the coextrusion blowing process.

While it is still in bubble form, the film can be oriented after appropriate temperature regulation, while the orientation operation can be carried out transversely, i.e. around the circumference, longitudinally or biaxially at the same time. After this, the film can be collapsed and subjected to a further orientation process following appropriate temperature regulation.

In the simplest case, what is involved in this context is longitudinal orientation, which is carried out via a roller gap, for example. Transverse orientation, transverse and longitudinal orientation and simultaneous biaxial orientation are, however, possible, which can be carried out in the form of roller or gripper orientation operations.

Siliconization on one or both sides is also possible inline, with solvent-based, solvent-free, UV electron beam curing or emulsion silicone systems being possible options. It is, however, also conceivable that the silicone layer is coextruded together with the other film layers. The film manufactured in this way is suitable as a release liner, e.g. for labels and adhesive tapes etc., due to the very favourable properties.

Since the tear strength can be varied, it has been possible to use the film as an excellent substitute for release paper. On the other hand, however, use of the film in easy-opening applications is conceivable too, if the tear strength properties are set to be low enough.

Accordingly, while only a few embodiments of the present invention have been shown and described, it is obvious that many changes and modifications may be made thereunto without departing from the spirit and scope of the invention.

What is claimed is:

1. A process for the production of an oriented plastic film from polyolefins and/or combinations of polyolefins and polyamide, comprising:
carrying out an extrusion or coextrusion blowing process to create a film; and
carrying out an orientation operation comprising:
(1) an initial biaxial orientation operation during the blowing process; and
(2) a second orientation operation.

2. A process according to claim 1, wherein the second orientation operation is carried out directly after the initial orientation.

3. A process according to claim 1, wherein the second orientation operation is carried out independently of the initial orientation.

4. A process according to claim 1, wherein at least the initial orientation is carried out simultaneously biaxially.

5. A process according to claim 1, wherein a temperature of the blown film for orientation is set at 90 to 180° C.

6. A process according to claim 5, wherein temperature regulation rollers are used to regulate the temperature of the film before the second orientation operation and set the film temperature at about 100 to 180° C.

7. A process according to claim 5, wherein the film is heated up to the orientation temperature of about 100 to 180° C. by radiant heaters before the second orientation operation.

8. A process according to claim 1, wherein the film temperature is regulated after the orientation operation, with a temperature of 90 to 180° C. being reached in the film.

9. A process according to claim 1, wherein the film is cooled and then wound.

10. A process according to claim 1, wherein a finished inner or outer layer is fed in, to which the further layers are applied by a coextrusion blowing process.

11. A process according to claim 1, wherein the film is siliconized with a silizonization agent on one or both sides.

12. A process according to claim 11, wherein the siliconization agent is extruded together with the film.

13. A process according to claim 11, wherein the siliconization agent is applied by extrusion after extrusion of the film.

14. A process according to claim 1 wherein the orientation operation is carried out with a ratio of between 3:1 and 25:1.

15. A process according to claim 1, wherein during extrusion of the film, a blown film bubble is created and the blown film bubble is collapsed and bonded to itself, or another layer of film is fed in before the second orientation operation, to create a two-layer film.

16. A process according to claim 15, wherein the film layers are treated so they are able to slip on each other at room temperature.

17. A process according to claim 15, wherein the film is made from a bubble, and the bubble is stuck together.

18. A process according to claim 15, wherein the film has a layer that melts at a low temperature.

19. A process according to claim 18, wherein the layer that melts at a low temperature is made from PE.

20. A process according to claim 18, wherein the film layers are bonded to each other by orientation via the layer that melts at a low temperature.

21. A process according to claim 20, wherein the film layers are stuck together by the orientation operation.

22. A process according to claim 20, wherein adhesion between the film layers is increased by the orientation operation so that the layers stick to each other sufficiently.

23. A process according to claim 1, wherein the second orientation operation is carried out in the form of roller orientation.

24. A process according to claim 1, wherein the second orientation operation is carried out in the form of gripper orientation.

25. A process according to claim 1, wherein during the blowing process a film bubble is created that is structured as a multilayer coextrudate.

26. A process according to claim 1, wherein the film is formed as a multilayer composite before the second orientation operation is carried out.

27. A process according to claim 1, wherein the film has at least one layer produced from polyamide.

28. A process according to claim 1, wherein the film has at least one layer produced from polypropylene.

29. A process according to claim 1, wherein the film has at least one layer produced from polyethylene.

30. A process according to claim 1, wherein the film has at least one layer provided with fillers.

31. A process according to claim 30, wherein the fillers are microcapsules.

32. A process according to claim 1, wherein the film has at least one layer that is foamed.

33. A process according to claim 32, wherein the foaming process is carried out by microcapsules.

34. A process according to claim 1, wherein the film has at least one layer having amorphous areas.

35. A process according to claim 34, wherein the amorphous areas are structured so that they are still amorphous during and after the orientation operation.

36. A film produced from polyolefins or combinations of polyolefins and polyamide, the film being produced from a an extrusion or coextrusion blowing process and being oriented by an initial biaxial orientation operation during the blowing process and a second orientation operation.

37. A film according to claim 36, wherein the film has optical properties.

38. A film according to claim 37, wherein the film is transparent.

39. A film according to claim 36, wherein the film is structured so that it displays minimal shrinkage.

40. A film according to claim 36, wherein the film has good tear properties.

41. A film according to claim 36, wherein the film has poor tear properties.

42. A film according to claim 36, wherein tear properties of the film are determined by partial or complete adhesion of individual film layers to each other.

43. A film according to claim 36, wherein the film is formed from individual thin film layers.

44. A film according to claim 36, wherein the film comprises a plurality of film layers, which form a film composite together.

45. A film according to claim 44, wherein the entire composite is oriented and the thickness of the composite is reduced significantly during the orientation operation.
